(19) United States
(12) Patent Application Publication
(10) Pub. No.: US 2009/0217805 A1
(43) Pub. Date: Sep. 3, 2009

(54) MUSIC GENERATING DEVICE AND OPERATING METHOD THEREOF

(75) Inventors: Jeong Soo Lee, Seoul (KR); In Jae Lim, Gyeongi-do (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 12/092,902

(22) PCT Filed: Dec. 21, 2006
(86) PCT No.: PCT/KR2006/005624

§ 371 Date: Oct. 9, 2008

(30) Foreign Application Priority Data
Dec. 21, 2005 (KR) 10-2005-0127129

(51) Int. Cl. G10H 1/40; G10H 1/38

(52) U.S. Cl. 84/611; 84/613

(57) ABSTRACT

Provided is a music generating device. The device includes a user interface, a lyric processing module, a melody generating unit, a harmony accompaniment generating unit, and a music generating unit. The user interface receives lyrics and melody from a user, and the lyric processing module generates a voice file corresponding to the received lyrics. The melody generating unit generates a melody file corresponding to the received melody, and the harmony accompaniment generating unit analyzes the melody file to generate a harmony accompaniment file corresponding to the melody. The music generating unit synthesizes the voice file, the melody file, and the harmony accompaniment file to generate a music file.

### TECHNICAL FIELD

The present invention relates to a music generating device and an operating method thereof.

### BACKGROUND ART

Music is formed using three factors of melody, harmony, and rhythm. Music changes depending on an age, and exists in a friendly aspect in everyday lives of people.

Melody is a most fundamental factor constituting music. Melody is a factor most effectively representing musical expression and human emotion. Melody is linear connection formed by horizontally combining notes having various pitches and lengths. Assuming that harmony is simultaneous (vertical) combination of a plurality of notes, melody is a horizontal arrangement of single notes having different pitches. However, the arrangement of single notes should be organized using a time order, i.e., rhythm to provide musical meaning to this musical sequence.

A person composes a musical piece by expressing his emotion using melody, and completes a song by adding lyrics to the musical piece. However, there is much difficulty for an ordinary people, who are not a musical expert, to create even harmony accompaniment and rhythm accompaniment suitable for lyrics and melody of his own making. Therefore, a study on a music generating device is in progress to automatically generate harmony accompaniment and rhythm accompaniment suitable for lyrics and melody when a user expresses his emotion using the lyrics and the melody.

### DISCLOSURE OF INVENTION

### Technical Problem

An object of the present invention is to provide a music generating device and an operating method thereof, capable of automatically generating harmony accompaniment and rhythm accompaniment suitable for expressed lyrics and melody.

Another object of the present invention is to provide a portable terminal having a music generating module for automatically generating harmony accompaniment and rhythm accompaniment suitable for expressed lyrics and melody, and an operating method thereof.

Further another object of the present invention is to provide a mobile communication terminal having a music generating module for automatically generating harmony accompaniment and rhythm accompaniment suitable for expressed lyrics and melody to use a musical piece generated by the music generating module as a bell sound, and an operating method thereof.

### Technical Solution

To achieve above-described objects, there is provided a music generating device including: a user interface for receiving lyrics and melody from a user; a lyric processing module for generating a voice file corresponding to the received lyrics; a melody generating unit for generating a melody file corresponding to the received melody; a harmony accompaniment generating unit for analyzing the melody file to generate a harmony accompaniment file corresponding to the melody; and a music generating unit for synthesizing the voice file, the melody file, and the harmony accompaniment file to generate a music file.

According to another aspect of the present invention, there is provided a method for operating a music generating device, the method including: receiving lyrics and melody via a user interface; generating a voice file corresponding to the received lyrics and generating a melody file corresponding to the received melody; analyzing the melody file to generate a harmony accompaniment file suitable for the melody; and synthesizing the voice file, the melody file, and the harmony accompaniment file to generate a music file.

According to further another aspect of the present invention, there is provided a music generating device including: a user interface for receiving lyrics and melody from a user; a lyric processing module for generating a voice file corresponding to the received lyrics; a melody generating unit for generating a melody file corresponding to the received melody; a chord detecting unit for analyzing the melody file to detect a chord for each measure constituting the melody; an accompaniment generating unit for generating a harmony/rhythm accompaniment file corresponding to the melody with reference to the detected chord; and a music generating unit for synthesizing the voice file, the melody file, and the harmony/rhythm accompaniment file to generate a music file.

According to yet another aspect of the present invention, there is provided a method for operating a music generating device, the method including: receiving lyrics and melody via a user interface; generating a voice file corresponding to the received lyrics and generating a melody file corresponding to the received melody; analyzing the melody file to generate a harmony/rhythm accompaniment file suitable for the melody; and synthesizing the voice file, the melody file, and the harmony/rhythm accompaniment file to generate a music file.

According to yet another aspect of the present invention, there is provided a portable terminal including: a user interface for receiving lyrics and melody from a user; and a music generating module for generating a voice file corresponding to the received lyrics, generating a melody file corresponding to the received melody, analyzing the generated melody file to generate a harmony accompaniment file corresponding to the melody, and synthesizing the voice file, the melody file, and the harmony accompaniment file to generate a music file.

According to yet further another aspect of the present invention, there is provided a portable terminal including: a user interface for receiving lyrics and melody from a user; and a music generating module for generating a voice file corresponding to the received lyrics, generating a melody file corresponding to the received melody, analyzing the generated melody file to detect a chord for each measure constituting the melody, generating a harmony/rhythm accompaniment file corresponding to the melody with reference to the detected chord, and synthesizing the voice file, the melody file, and the harmony/rhythm accompaniment file to generate a music file.

According to still yet further another aspect of the present invention, there is provided a mobile communication terminal including: a user interface for receiving lyrics and melody from a user; and a music generating module for generating a voice file corresponding to the received lyrics, generating a melody file corresponding to the received melody, analyzing the generated melody file to generate an accompaniment file having harmony accompaniment corresponding to the melody, synthesizing the voice file, the melody file, the accompaniment file to generate a music file; a bell sound selecting unit for selecting the music file generated by the music generating module as a bell sound; and a bell sound reproducing unit for reproducing the music file selected by the bell sound selecting unit as the bell sound when communication is connected.

According to another aspect of the present invention, there is provided a method for operating a mobile communication terminal, the method including: receiving lyrics and melody through a user interface; generating a voice file corresponding to the received lyrics and generating a melody file corresponding to the received melody; analyzing the melody file to generate an accompaniment file having harmony accompaniment suitable for the melody; synthesizing the voice file, the melody file, and the accompaniment file to generate a music file; selecting the generated music file as a bell sound; and when communication is connected, reproducing the selected music file as the bell sound.

### ADVANTAGEOUS EFFECTS

According to a music generating device and an operating method thereof, harmony accompaniment and rhythm accompaniment suitable for expressed lyrics and melody can be automatically generated.

Also, according to a portable terminal and an operating method thereof, harmony accompaniment and rhythm accompaniment suitable for expressed lyrics and melody can be automatically generated.

Also, according to a mobile communication terminal and an operating method thereof, a music generating module for automatically generating harmony accompaniment and rhythm accompaniment suitable for expressed lyrics and melody is provided, so that a musical piece generated by the music generating module can be used as a bell sound.

### BRIEF DESCRIPTION OF THE DRAWINGS

FIG. 1 is a schematic block diagram of a music generating device according to a first embodiment of the present invention;

FIG. 2 is a view illustrating an example where melody is input using a humming mode to a music generating device according to a first embodiment of the present invention;

FIG. 3 is a view illustrating an example where melody is input using a keyboard mode to a music generating device according to a first embodiment of the present invention;

FIG. 4 is a view illustrating an example where melody is input using a score mode to a music generating device according to a first embodiment of the present invention;

FIG. 5 is a schematic block diagram of a character processing part of a music generating device according to a first embodiment of the present invention;

FIG. 6 is a schematic block diagram of a voice converting part of a music generating device according to a first embodiment of the present invention;

FIG. 7 is a flowchart illustrating a method of operating a music generating device according to a first embodiment of the present invention;

FIG. 8 is a schematic block diagram of a music generating device according to a second embodiment of the present invention;

FIG. 9 is a schematic block diagram of a chord detecting part of a music generating device according to a second embodiment of the present invention;

FIG. 10 is a view explaining measure classification in a music generating device according to a second embodiment of the present invention;

FIG. 11 is a view illustrating chord is set to measure classified by a music generating device according to a second embodiment of the present invention;

FIG. 12 is a schematic block diagram illustrating an accompaniment generating part of a music generating device according to a second embodiment of the present invention;

FIG. 13 is a flowchart illustrating a method of operating a music generating device according to a second embodiment of the present invention;

FIG. 14 is a schematic view of a portable terminal according to a third embodiment of the present invention;

FIG. 15 is a flowchart illustrating a method of operating a portable terminal according to a third embodiment of the present invention;

FIG. 16 is a schematic block diagram of a portable terminal according to a fourth embodiment of the present invention;

FIG. 17 is a schematic flowchart illustrating a method of operating a portable terminal according to a fourth embodiment of the present invention;

FIG. 18 is a schematic block diagram of a mobile communication terminal according to a fifth embodiment of the present invention;

FIG. 19 is a view illustrating a data structure exemplifying a kind of data stored in a storage of a mobile communication terminal according to a fifth embodiment of the present invention; and

FIG. 20 is a flowchart illustrating a method of operating a mobile communication terminal according to a fifth embodiment of the present invention.

### MODE FOR THE INVENTION

Hereinafter, preferred embodiments of the present invention will be described in detail with reference to accompanying drawings.

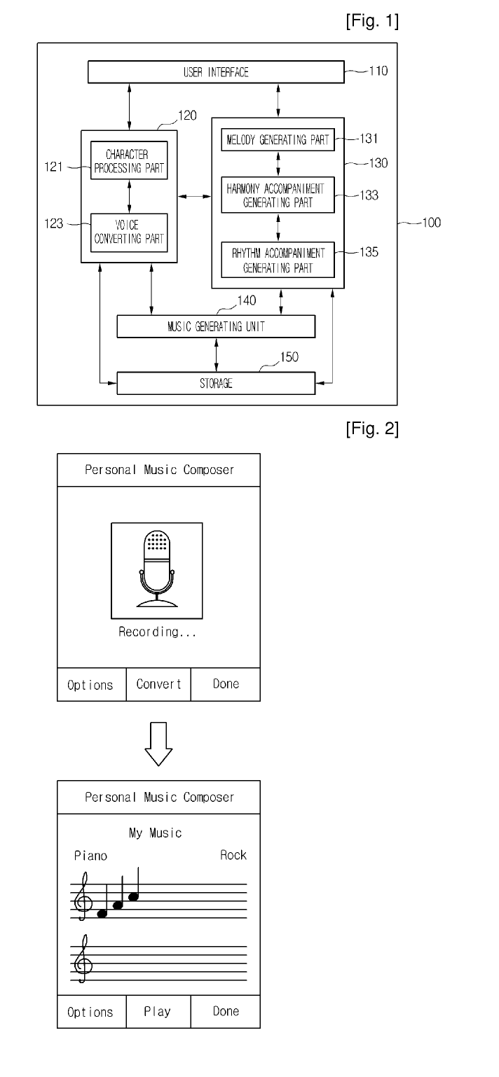

FIG. 1 is a schematic block diagram of a music generating device according to a first embodiment of the present invention.

Referring to FIG. 1, a music generating device 100 according to a first embodiment of the present invention includes a user interface 110, a lyric processing module 120, a composing module 130, a music generating unit 140, and a storage 150. The lyric processing module 120 includes a character processing part 121 and a voice converting part 123. The composing module 130 includes a melody generating part 131, a harmony accompaniment generating part 133, and a rhythm accompaniment generating part 135.

The user interface 110 receives lyrics and melody from a user. Here, the melody received from a user means linear connection of notes formed by horizontal combination of notes having pitch and duration.

The character processing part 121 of the lyric processing module 120 divides enumeration of input simple characters into meaningful words or word-phrases. The voice converting part 123 of the lyric processing module 120 generates a voice file corresponding to input lyrics with reference to processing results at the character processing part 121. The generated voice file can be stored in the storage 150. At this point, tone qualities such as those of woman/man/soprano voice/husky voice/child can be selected from a voice database.

The melody generating part 131 of the composing module 130 can generate a melody file corresponding to melody input through the user interface 110, and store the generated melody file in the storage 150.

The harmony accompaniment generating part 133 of the composing module 130 analyses a melody file generated by the melody generating part 131 and detects harmony suitable for melody contained in the melody file to generate a harmony accompaniment file. The harmony accompaniment file generated by the harmony accompaniment generating part 133 can be stored in the storage 150.

The rhythm accompaniment generating part 135 of the composing module 130 analyzes the melody file generated by the melody generating part 131 and detects rhythm suitable for melody contained the melody file to generate a rhythm accompaniment file. The rhythm accompaniment generating part 135 can recommend an appropriate rhythm style to a user through analysis of the melody. Also, the rhythm accompaniment generating part 135 may generate a rhythm accompaniment file in accordance with a rhythm style requested by a user. The rhythm accompaniment file generated by the rhythm accompaniment generating part 135 can be stored in the storage 150.

The music generating unit 140 can synthesize a melody file, a voice file, and a harmony accompaniment file, and a rhythm accompaniment file stored in the storage 150 to generate a music file, and store the generated music file in the storage 150.

The music generating device 100 according to the present invention receives only lyrics and melody simply and generates and synthesizes harmony accompaniment and rhythm accompaniment suitable for the received lyrics and melody to provide a music file. Accordingly, even an ordinary people, not a musical expert, can easily compose excellent music.

Lyrics and melody can be received from a user in various ways. The user interface 110 can be modified in various ways depending on a way the lyrics and melody are received from the user.

For example, melody can be received in a humming mode from a user. FIG. 2 is a view illustrating an example where melody is input using a humming mode to a music generating device according to a first embodiment of the present invention.

A user can input melody of his own making to the music generating device 100 according to the present invention through humming. The user interface 110 includes a microphone to receive melody from the user. Also, the user can input melody of his own making through a way the user sings a song.

The user interface 110 can further include an image display part to display a humming mode is being performed on the image display part as illustrated in FIG. 2. The image display part can be allowed to display a metronome thereon, and the user can control speed of input melody with reference to the metronome.

After inputting the melody is completed, the user can request the input melody to be checked. The user interface 110 can output the melody input by the user through a speaker, and can display the melody on the image display part in the form of a musical score as illustrated in FIG. 2. Also, the user can select a musical note to be modified and change pitch and/or duration of the selected musical note on the musical score displayed on the user interface 110.

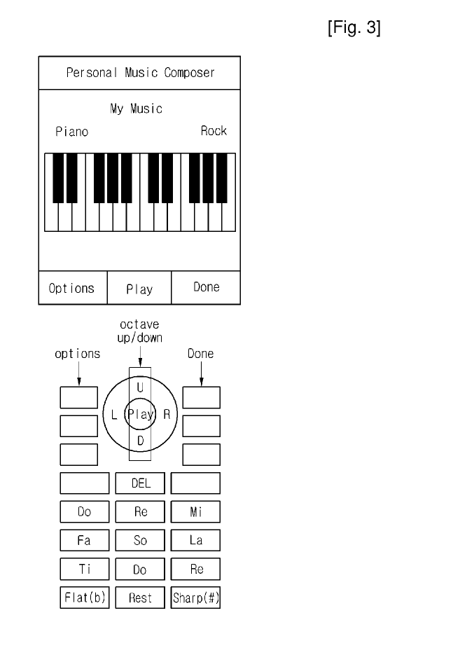

Also, the user interface 110 can receive melody from the user using a keyboard mode. FIG. 3 is a view illustrating an example where melody is input using a keyboard mode to a music generating device according to a first embodiment of the present invention.

The user interface 110 displays a keyboard-shaped image on the image display part and detects pressing/release of a button corresponding to a set musical scale to receive melody from the user. Since musical scales (e.g., Do, Re, Mi, Fa, Sol, La, Si, and Do) are assigned to buttons, respectively, a button selected by a user can be detected and pitch data of a note can be obtained. Also, duration data of a predetermined note can be obtained by detecting a time during which the button is pressed. At this point, it is possible to allow a user to select an octave by providing a selection button for raising or lowering the octave.

A metronome can be displayed on the image display part, and a user can control speed of input melody with reference to the metronome. After inputting the melody is completed, the user can request the input melody to be checked. The user interface 110 can output the melody input by the user through a speaker, and can display the melody on the image display part in the form of a musical score. Also, the user can select a musical note to be modified and change pitch and/or duration of the selected musical note on the musical score displayed on the user interface 110.

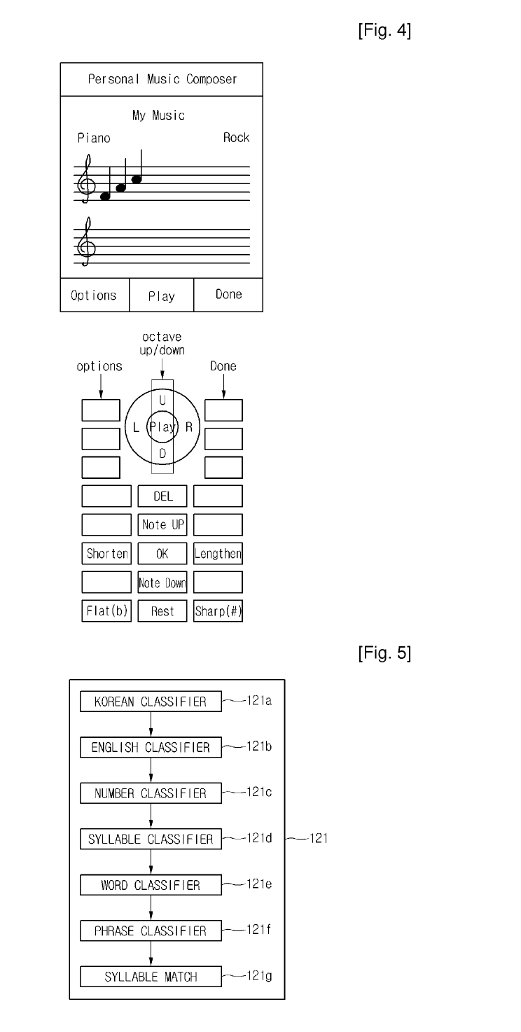

Also, the user interface 110 can receive melody from the user using a score mode. FIG. 4 is a view illustrating an example where melody is input to a music generating device using a score mode according to a first embodiment of the present invention.

The user interface 110 can display a score on the image display part and receive melody from a user manipulating the buttons. For example, a note having a predetermined pitch and a predetermined duration is displayed on a score. The user can raise a height of the note by pressing a first button (Note Up), and lower the height of the note by pressing a second button (Note Down). Also, the user can lengthen duration of the note by pressing a third button (Lengthen), and shorten the duration of the note by pressing a fourth button (Shorten). Accordingly, the user can input pitch data and duration data of a predetermined note, and input melody of his own making by repeatedly performing this procedure.

After inputting the melody is completed, the user can request the input melody to be checked. The user interface 110 can output the melody input by the user through a speaker, and can display the melody on the image display part in the form of a musical score. Also, the user can select a musical note to be modified and change pitch and/or duration of the selected musical note on the musical score displayed on the user interface 110.

Meanwhile, lyrics can be received from a user in various ways. The user interface 110 can be modified in various ways depending on a way the lyrics are received from the user. The lyrics can be received separately from the above received melody. The lyrics can be received to a score to correspond to notes constituting the melody. The receiving of the lyrics can be processed using a song sung by the user, or through a simple character input operation.

The harmony accompaniment generating part 133 performs a basic melody analysis for accompaniment on the melody file generated by the melody generating part 131. The harmony accompaniment generating part 133 performs selection of chord on the basis of analysis materials corresponding to each of measures constituting the melody. Here, the chord is an element set for each measure for harmony accompaniment. The chord is a term used for discrimination from an overall harmony of a whole musical piece.

For example, when a user plays a guitar while singing a song, he plays the guitar using chords set on respective measures. At this point, a portion for singing a song corresponds to an operation of composing melody, and judging and selecting chord suitable for the song each moment corresponds to an operation of the harmony accompaniment generating part 133.

FIG. 5 is a schematic block diagram of a character processing part of a music generating device according to a first embodiment of the present invention.

The character processing part 121 includes a Korean classifier 121a, an English classifier 121b, a number classifier 121c, a syllable classifier 121d, a word classifier 121e, a phrase classifier 121f, and a syllable match 121g.

The Korean classifier 121a classifies Korean characters from received characters. The English classifier 121b classifies English characters and converts the English characters into Korean characters. The number classifier 121c converts numbers into Korean characters. The syllable classifier 121d separates converted characters into syllables which are minimum units of sounds. The word classifier 121e separates the received characters into words which are minimum units of meaning. The word classifier 121e prevents one word from being unclear in meaning or awkward in expression when the one word is enumerated over two measures. The phrase classifier 121f provides spacing words of characters and contributes to allowing a rest portion or a switching portion in the interim of melody to be divided by a phrase unit. Through the above process, more natural conversion can be performed when received lyrics are converted into voices. The syllable match 121g matches each note data constituting melody with each character with reference to the above-classified data.

FIG. 6 is a schematic block diagram of a voice converting part of a music generating device according to a first embodiment of the present invention.

The voice converting part 123 includes a syllable pitch applier 123a, a syllable duration applier 123b, and an effect applier 123c.

The voice converting part 123 actually generates a voice by one note using syllable data assigned to each note and generated by the character processing part 121. First, selection can be made regarding to which voice the lyrics received from a user is to be converted. At this point, the selected voice can be realized with reference to a voice database, and tone qualities of woman/man/soprano voice/husky voice/child can be selected.

The syllable pitch applier 123a changes pitch of a voice stored in a database using a note analyzed by the composing module 130. The syllable duration applier 123b calculates a duration of a voice using a note duration and applies the calculated duration. The effect applier 123c applies changes to predetermined data stored in a voice database using various control messages of melody. For example, the effect applier 123c can make a person feel as if the person sang a song in person by providing various effects such as speed, accent, and intonation. Through the above process, the lyric processing module 120 can analyze lyrics received from a user and generate a voice file suitable for the received lyrics.

Meanwhile, description has been made to the case of generating a music file by adding harmony accompaniment and/or rhythm accompaniment to lyrics and melody received through the user interface 110. However, when lyrics and melody are received, lyrics and melody of a user's own making can be received. Also, existing lyrics and melody can be received. For example, the user can load the existing lyrics and melody, and modify them to make new lyrics and melody.

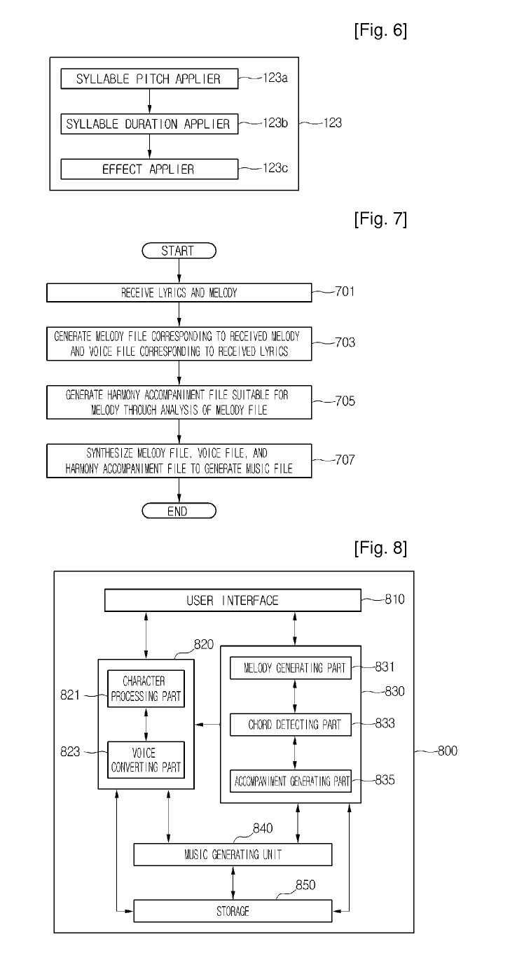

FIG. 7 is a flowchart illustrating a method of operating a music generating device according to a first embodiment of the present invention.

First, lyrics and melody are received through the user interface 110 (operation 701).

A user can input melody of his own making to the music generating device 100 through humming. The user interface 110 includes a microphone to receive melody from the user. Also, the user can input melody of his own making by singing a song himself.

Also, the user interface 110 can receive melody from the user using a keyboard mode. The user interface 110 displays a keyboard-shaped image on the image display part and detects pressing/release of a button corresponding to a set musical scale to receive melody from the user. Since musical scales (e.g., Do, Re, Mi, Fa, Sol, La, Si, and Do) are assigned to buttons, respectively, a button selected by a user can be detected and pitch data of a note can be obtained. Also, duration data of a predetermined note can be obtained by detecting a time during which the button is pressed. At this point, it is possible to allow a user to select an octave by providing a selection button for raising or lowering the octave.

Also, the user interface 110 can receive melody from the user using a score mode.

The user interface 110 can display a score on the image display part and receive melody from a user manipulating the buttons. For example, a note having a predetermined pitch and a predetermined duration is displayed on a score. The user can raise a height of the note by pressing a first button (Note Up), and lower the height of the note by pressing a second button (Note Down). Also, the user can lengthen duration of the note by pressing a third button (Lengthen), and shorten the duration of the note by pressing a fourth button (Shorten). Accordingly, the user can input pitch data and duration data of a predetermined note, and input melody of his own making by repeatedly performing this procedure.

Meanwhile, lyrics can be received from a user in various ways. The user interface 110 can be modified in various ways depending on a way the lyrics are received from the user. The lyrics can be received separately from the above input melody. The lyrics can be received to a score to correspond to notes constituting the melody. The inputting of the lyrics can be processed while the user sings a song, or through a simple character input operation.

When lyrics and melody are received through the user interface 110, the lyric processing module 120 generates a voice file corresponding to the received lyrics, and the melody generating part 131 of the composing module 130 generates a melody file corresponding to the received melody (operation 703). The voice file generated by the lyric processing module 120, and the melody file generated by the melody generating part 131 can be stored in the storage 150.

Also, the harmony accompaniment generating part 133 analyzes the melody file to generate a harmony accompaniment file suitable for the melody (operation 705). The harmony accompaniment file generated by the harmony accompaniment generating part 133 can be stored in the storage 150.

The music generating unit 140 of the music generating device 100 synthesizes the melody file, the voice file, and the harmony accompaniment file to generate a music file (operation 707). The music file generated by the music generating unit 140 can be stored in the storage 150.

Meanwhile, though description has been made to only the case where a harmony accompaniment file is generated in operation 705, a rhythm accompaniment file can be further generated through analysis of the melody file generated in operation 703. In the case where the rhythm accompaniment file is further generated, the melody file, the voice file, the harmony accompaniment file, and the rhythm accompaniment file are synthesized to generate a music file in operation 707.

The music generating device 100 simply receives only lyrics and melody from a user, generates harmony accompaniment and rhythm accompaniment suitable for the received lyrics and melody, and synthesize them to provide a music file. Accordingly, even an ordinary people, not a musical expert, can easily compose excellent music.

Meanwhile, FIG. 8 is a schematic block diagram of a music generating device according to a second embodiment of the present invention.

Referring to FIG. 8, the music generating device 800 according to the second embodiment of the present invention includes a user interface 810, a lyric processing module 820, a composing module 830, a music generating unit 840, and a storage 850. The lyric processing module 820 includes a character processing part 821 and a voice converting part 823. The composing module 830 includes a melody generating part 831, a chord detecting part 833, and an accompaniment generating part 835.

The user interface 810 receives lyrics and melody from a user. Here, the melody received from a user means linear connection of notes formed by horizontal combination of notes having pitch and duration.

The character processing part 821 of the lyric processing module 820 discriminates enumeration of simple input characters into words or word-phrases. The voice converting part 823 of the lyric processing module 820 generates a voice file corresponding to input lyrics with reference to processing results at the character processing part 821. The generated voice file can be stored in the storage 850. At this point, tone qualities such as those of woman/man/soprano voice/husky voice/child can be selected from a voice database.

The melody generating part 831 of the composing module 830 can generate a melody file corresponding to melody input through the user interface 810, and store the generated melody file in the storage 850.

The chord detecting part 833 of the composing module 830 analyzes the melody file generated by the melody generating part 831, and detects chord suitable for the melody. The detected chord can be stored in the storage 850.

The accompaniment generating part 835 generates an accompaniment file with reference to the chord detected by the chord detecting part 833. Here, the accompaniment file means a file containing both harmony accompaniment and rhythm accompaniment. The accompaniment file generated by the accompaniment generating part 835 can be stored in the storage 850.

The music generating unit 840 can synthesize the melody file, the voice file, and the accompaniment file stored in the storage 850 to generate a music file, and store the generated music file in the storage 850.

The music generating device 800 simply receives only lyrics and melody from a user, generates harmony accompaniment/rhythm accompaniment suitable for the received lyrics and melody, and synthesize them to provide a music file. Accordingly, even an ordinary people, not a musical expert, can easily compose excellent music.

Melody can be received from a user in various ways. The user interface 810 can be modified in various ways depending on a way the melody is received from the user. Melody can be received from the user through modes such as a humming mode, a keyboard mode, and a score mode.

Meanwhile, lyrics can be received from a user in various ways. The user interface 810 can be modified in various ways depending on a way the lyrics are received from the user.

Lyrics can be received from a user in various ways. The user interface 110 can be modified in various ways depending on a way the lyrics are received from the user. The lyrics can be received separately from the above received melody. The lyrics can be received to a score to correspond to notes constituting the melody. The receiving of the lyrics can be processed using a song sung by the user, or through a simple character input operation.

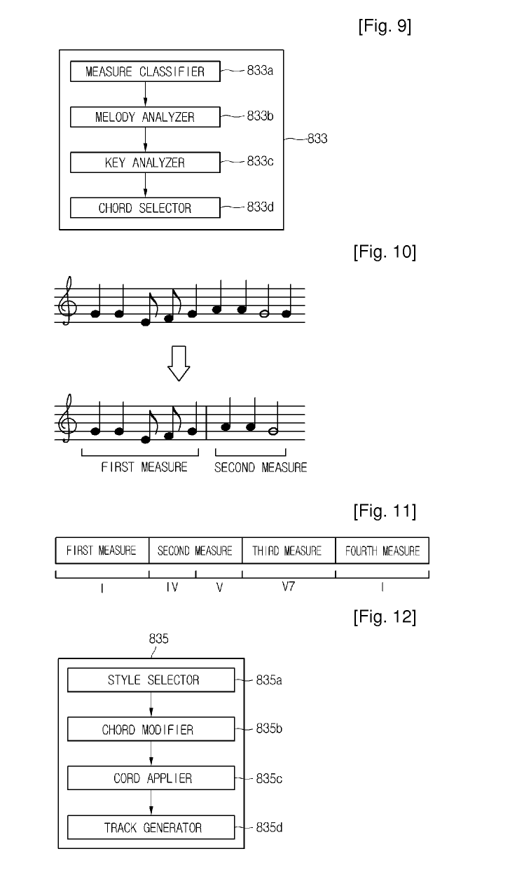

Then, an operation for detecting chord suitable for melody received by the chord detecting part 833 of the composing module 830 will be described with reference to FIGS. 9 to 11. The operation for detecting chord that is to be described below can be applied to the music generating device 100 according to the first embodiment of the present invention.

FIG. 9 is a schematic block diagram of a chord detecting part of a music generating device according to the second embodiment of the present invention, FIG. 10 is a view explaining measure classification in a music generating device according to the second embodiment of the present invention, and FIG. 11 is a view illustrating chord is set to measure classified by a music generating device according to the second embodiment of the present invention.

Referring to FIG. 9, the chord detecting part 833 of the composing module 830 includes a measure classifier 833a, a melody analyzer 833b, a key analyzer 833c, and a chord selector 833d.

The measure classifier 833a analyzes received melody to divide measure to be suitable for a predetermine time designated in advance. For example, in the case of a musical piece having a four-four time, duration of notes is calculated by a four-time unit and divided on a music sheet (refer to FIG. 10). In the case where notes are arranged across a measure, the notes can be divided using a tie.

The melody analyzer 833b classifies notes of melody into a twelve-tone scale and gives weight to the notes according to the duration of each note (one octave is divided into twelve tones, and for example, one octave consists of twelve tones represented by twelve keyboards including a white keyboard and a black keyboard in keyboards of a piano). For example, since influence determining chord is high as duration of a note is lengthened, high weight is given to a note having a relatively long duration and small weight is given to a note having a relatively short duration. Also, an accent condition suitable for time is considered. For example, a musical piece of a four-four time has a rhythm of strong/weak/intermediate/weak, in which a higher weight is given to a note corresponding to strong/intermediate rather than other notes to allow the note corresponding to strong/intermediate rhythm to have much influence when chord is selected.

As described above, the melody analyzer 833b gives weight where various conditions are summed for respective notes to provide melody analysis materials so that most harmonious accompaniment is achieved when chord is selected afterward.

The key analyzer 833c judges which major/minor key a whole musical piece has using the materials analyzed by the melody analyzer 833b. Key includes C major, G major, D major, and A major determined by the number of # (sharp), and also includes F major, Bb major, and Eb major determined by the number of b (flat). Since chord used for each key is different, this analysis is required.

The chord selector 833d maps a chord most suitable for each measure with reference to key data analyzed by the key analyzer 833c and weight data analyzed by the melody analyzer 833b. The chord selector 833d can assign a chord to one measure, or assign a chord to half measure depending on distribution of notes when assigning chord for each measure. Referring to FIG. 11, I chord can be selected for a first measure, IV chord or V chord can be selected for a second measure. FIG. 11 illustrates IV chord is selected for a front half of the second measure, and V chord is selected for a rear half of the second measure.

Through the above process, the chord detecting part 833 of the composing module 830 can analyze melody received from a user, and detect chord corresponding to each measure.

FIG. 12 is a schematic block diagram illustrating an accompaniment generating part of a music generating device according to the second embodiment of the present invention.

Referring to FIG. 12, the accompaniment generating part 835 of the composing module 830 includes a style selector 835a, a chord modifier 835b, a chord applier 835c, and a track generator 835d.

The style selector 835a selects a style of accompaniment to be added to melody received from a user. The accompaniment style includes hip-hop, dance, jazz, rock, ballad, and trot. The accompaniment style to be added to the melody received from the user may be selected by the user. A chord file according to each style can be stored in the storage 850. Also, the chord file according to each style can be generated for each instrument. The instrument includes a piano, a harmonica, a violin, a cello, a guitar, and a drum. The chord file corresponding to each instrument can be generated in duration of one measure and formed of basic I chord. Of course, a chord file according to each style may be managed as a separate database, and may be provided as other chord such as a IV chord and a V chord.

Since a hip-hop style selected by the style selector 835a includes basic I chord, but measure detected by the chord detecting part 833 may be matched to IV chord or V chord, not basic I chord, the chord modifier 835b modifies a chord according to a selected style into a chord of each measure actually detected by the chord detecting part 833. Accordingly, the chord modifier 835b performs an operation of modifying a chord into a chord suitable for actually detected measure. Of course, an operation of individually modifying a chard with respect to all instruments constituting a hip-hop style is performed.

The chord applier 835c sequentially connects chords modified by the chord modifier 835b for each instrument. For example, assuming that a hip-hop style is selected and a chord is selected as illustrated in FIG. 11, a I chord of a hip-hop style is applied to a first measure, a IV chord of a hip-hop style to a front half of a second measure, a V chord to a rear half of the second measure. Accordingly, the chord applier 835c sequentially connects chords of a hip-hop style suitable for respective measures. At this point, the chord applier 835c sequentially connects the chords of the respective measures for each instrument, and connects the chords depending on the number of instruments. For example, a piano chord of a hip-hop style is applied and connected, and a drum chord of a hip-hop style is applied and connected.

The track generator 835d generates an accompaniment file formed by chords connected for each instrument. This accompaniment file can be generated using respective independent MIDI (musical instrument digital interface) tracks formed by chords connected for each instrument. The above-generated accompaniment file can be stored in the storage 850.

The music generating unit 840 synthesizes a melody file, a voice file, an accompaniment file stored in the storage 850 to generate a music file. The music file generated by the music generating unit 840 can be stored in the storage 850. The music generating unit 840 can gather at least one MIDI track generated by track generator 835d and lyrics/melody tracks received from the user together with header data to generate one completed MIDI (musical instrument digital interface) file.

Meanwhile, though description has been made for the case where a music file is generated by adding accompaniment to lyrics/melody received through the user interface 810, not only lyrics/melody of the user's own making can be received, but also existing lyrics/melody can be received through the user interface 810. For example, the user can call the existing lyrics/melody stored in the storage 850, and may modify the existing lyrics/melody to make new one.

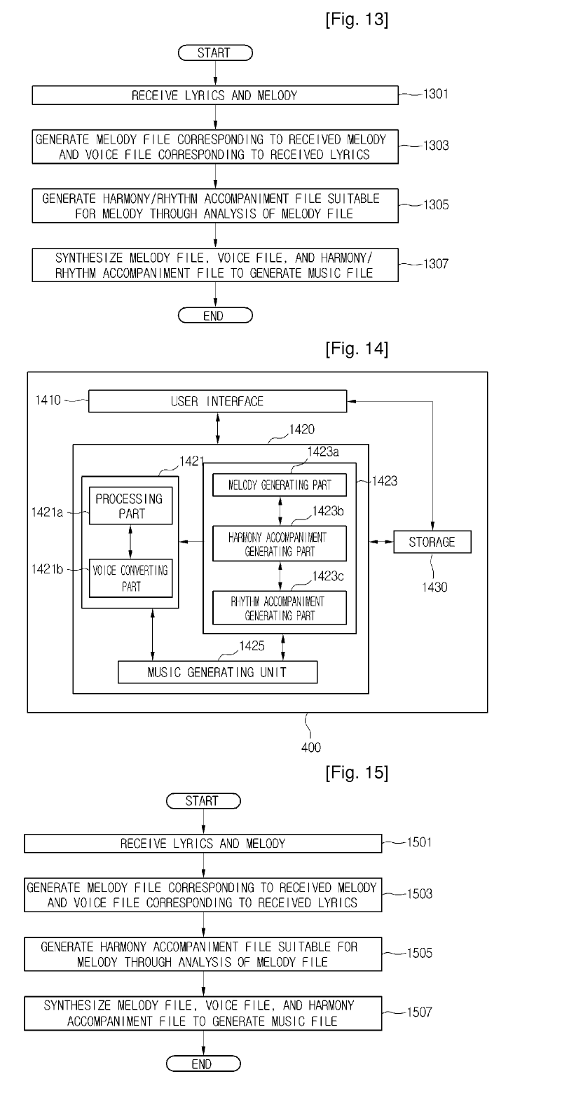

FIG. 13 is a flowchart illustrating a method of operating a music generating device according to the second embodiment of the present invention.

First, lyrics and melody are received through the user interface 810 (operation 1301).

A user can input melody of his own making to the music generating device 800 through humming. The user interface 810 includes a microphone to receive melody from the user. Also, the user can input melody of his own making by singing a song himself.

Also, the user interface 810 can receive melody from the user using a keyboard mode. The user interface 810 displays a keyboard-shaped image on the image display part and detects pressing/release of a button corresponding to a set musical scale to receive melody from the user. Since musical scales (e.g., Do, Re, Mi, Fa, Sol, La, Si, and Do) are assigned to buttons, respectively, a button selected by a user can be detected and pitch data of a note can be obtained. Also, duration data of a predetermined note can be obtained by detecting a time during which the button is pressed. At this point, it is possible to allow a user to select an octave by providing a selection button for raising or lowering the octave.

Also, the user interface 810 can receive melody from the user using a score mode. The user interface 810 can display a score on the image display part and receive melody from a user manipulating the buttons. For example, a note having a predetermined pitch and a predetermined duration is displayed on a score. The user can raise a height of the note by pressing a first button (Note Up), and lower the height of the note by pressing a second button (Note Down). Also, the user can lengthen duration of the note by pressing a third button (Lengthen), and shorten the duration of the note by pressing a fourth button (Shorten). Accordingly, the user can input pitch data and duration data of a predetermined note, and input melody of his own making by repeatedly performing this procedure.

Meanwhile, lyrics can be received from a user in various ways. The user interface 810 can be modified in various ways depending on a way the lyrics are received from the user. The lyrics can be received separately from the above input melody. The lyrics can be received to a score to correspond to notes constituting the melody. The inputting of the lyrics can be processed while the user sings a song, or through a simple character input operation.

When lyrics and melody are received through the user interface 810, the lyric processing module 820 generates a voice file corresponding to the received lyrics, and the melody generating part 831 of the composing module 830 generates a melody file corresponding to the received melody (operation 1303). The voice file generated by the lyric processing module 820, and the melody file generated by the melody generating part 831 can be stored in the storage 850.

The music generating device 800 analyzes melody generated by the melody generating part 831, and generates a harmony/rhythm accompaniment file suitable for the melody (operation 1305). The generated harmony/rhythm accompaniment file can be stored in the storage 850.

Here, the chord detecting part 833 of the music generating device 800 analyzes melody generated by the melody generating part 831, and detects a chord suitable for the melody. The detected chord can be stored in the storage 850.

The accompaniment generating part 835 of the music generating device 800 generates an accompaniment file with reference to the chord detected by the chord detecting part 833. Here, the accompaniment file means a file including both harmony accompaniment and rhythm accompaniment. The accompaniment file generated by the accompaniment generating part 835 can be stored in the storage 850.

Subsequently, the music generating unit 840 of the music generating device 800 synthesizes the melody file, the voice file, and the harmony/rhythm accompaniment file to generate a music file (operation 1307). The music file generated by the music generating unit 840 can be stored in the storage 850.

The music generating device 800 simply receives only lyrics and melody from a user, generates harmony/rhythm accompaniment suitable for the received lyrics and melody, and synthesize them to provide a music file. Accordingly, even an ordinary people, not a musical expert, can easily compose excellent music.

Meanwhile, FIG. 14 is a schematic view of a portable terminal according to a third embodiment of the present invention. Here, the portable terminal is used as a term generally indicating a terminal that can be carried by an individual. The portable terminal includes MP3 players, PDAs, digital cameras, mobile communication terminals, and camera phones.

Referring to FIG. 14, the portable terminal 1400 includes a user interface 1410, a music generating module 1420, and a storage 1430. The music generating module 1420 includes a lyric processing module 1421, a composing module 1423, and a music generating unit 1425. The lyric processing module 1421 includes a character processing part 1421a and a voice converting part 1421b. The composing module 1423 includes a melody generating part 1423a, a harmony accompaniment generating part 1423b, and a rhythm accompaniment generating part 1423c.

The user interface 1410 receives data, commands, and menu selection from a user, and provides sound data and visual data to the user. Also, the user interface 1410 receives lyrics and melody from the user. Here, the melody received from the user means linear connection of notes formed by horizontal combination of notes having pitch and duration.

The music generating module 1420 generates harmony accompaniment and/or rhythm accompaniment suitable for lyrics/melody received through the user interface 1410. The music generating module 1420 generates a music file where the generated harmony accompaniment and/or rhythm accompaniment are/is added to the lyrics/melody received from the user.

The portable terminal 1400 according to the present invention receives only lyrics and melody simply and generates and synthesizes harmony accompaniment and/or rhythm accompaniment suitable for the received lyrics and melody to provide a music file. Accordingly, even an ordinary people, not a musical expert, can easily compose an excellent musical piece.

The character processing part 1421a of the lyric processing module 1421 discriminates enumeration of simple input characters into meaningful words or word-phrases. The voice converting part 1421b of the lyric processing module 1421 generates a voice file corresponding to received lyrics with reference to processing results at the character processing part 1421a. The generated voice file can be stored in the storage 1430. At this point, tone qualities such as those of woman/man/soprano voice/husky voice/child can be selected from a voice database.

The melody generating part 1423a of the composing module 1423 generates a melody file corresponding to melody received through the user interface 1410, and store the generated melody file in the storage 1430.

The harmony accompaniment generating part 1423b of the composing module 1423 analyses a melody file generated by the melody generating part 1423a and detects harmony suitable for melody contained in the melody file to generate a harmony accompaniment file. The harmony accompaniment file generated by the harmony accompaniment generating part 1423b can be stored in the storage 1430.

The rhythm accompaniment generating part 1423c of the composing module 1423 analyzes the melody file generated by the melody generating part 1423a and detects rhythm suitable for melody contained the melody file to generate a rhythm accompaniment file. The rhythm accompaniment generating part 1423c can recommend an appropriate rhythm style to a user through analysis of the melody. Also, the rhythm accompaniment generating part 1423c may generate a rhythm accompaniment file in accordance with a rhythm style requested by a user. The rhythm accompaniment file generated by the rhythm accompaniment generating part 1423c can be stored in the storage 1430.

The music generating unit 1425 can synthesize a melody file, a voice file, and a harmony accompaniment file, and a rhythm accompaniment file stored in the storage 1430 to generate a music file, and store the generated music file in the storage 1430.

Melody can be received from a user in various ways. The user interface 1410 can be modified in various ways depending on a way the melody is received from the user.

For example, melody can be received from the user through a humming mode. The melody of the user's own making can be received to the portable terminal 1200 through a humming mode. The user interface 1410 includes a microphone to receive melody from a user. Also, the melody of the user's own making can be received to the portable terminal 1200 while a user sings a song.

The user interface 1410 can further include an image display part to display a humming mode is being performed on the image display part. The image display part can be allowed to display a metronome thereon, and the user can control speed of input melody with reference to the metronome.

After inputting the melody is completed, the user can request the input melody to be checked. The user interface 1410 can output the melody received by the user through a speaker, and can display the melody on the image display part in the form of a musical score. Also, the user can select a musical note to be modified and change pitch and/or duration of the selected musical note on the musical score displayed on the user interface 1410.

Also, the user interface 1410 can receive melody from the user using a keyboard mode. The user interface 1410 displays a keyboard-shaped image on the image display part and detects pressing/release of a button corresponding to a set musical scale to receive melody from the user. Since musical scales (e.g., Do, Re, Mi, Fa, Sol, La, Si, and Do) are assigned to buttons, respectively, a button selected by a user can be detected and pitch data of a note can be obtained. Also, duration data of a predetermined note can be obtained by detecting a time during which the button is pressed. At this point, it is possible to allow a user to select an octave by providing a selection button for raising or lowering the octave.

A metronome can be displayed on the image display part, and a user can control speed of input melody with reference to the metronome. After inputting the melody is completed, the user can request the input melody to be checked. The user interface 1410 can output the melody input by the user through a speaker, and can display the melody on the image display part in the form of a musical score. Also, the user can select a musical note to be modified and change pitch and/or duration of the selected musical note on the musical score displayed on the user interface 1410.

Also, the user interface 1410 can receive melody from the user using a score mode. The user interface 1410 can display a score on the image display part and receive melody from a user manipulating the buttons. For example, a note having a predetermined pitch and a predetermined duration is displayed on a score. The user can raise a height of the note by pressing a first button (Note Up), and lower the height of the note by pressing a second button (Note Down). Also, the user can lengthen duration of the note by pressing a third button (Lengthen), and shorten the duration of the note by pressing a fourth button (Shorten). Accordingly, the user can input pitch data and duration data of a predetermined note, and input melody of his own making by repeatedly performing this procedure.

After inputting the melody is completed, the user can request the input melody to be checked. The user interface 1410 can output the melody received from the user through a speaker, and can display the melody on the image display part in the form of a musical score. Also, the user can select a musical note to be modified and change pitch and/or duration of the selected musical note on the musical score displayed on the user interface 1410.

Meanwhile, lyrics can be received from a user in various ways. The user interface 1410 can be modified in various ways depending on a way the lyrics are received from the user. The lyrics can be received separately from the above received melody. The lyrics can be received to a score to correspond to notes constituting the melody. The receiving of the lyrics can be processed using a song sung by the user, or through a simple character receiving operation.

The harmony accompaniment generating part 1423b of the composing module 1423 performs a basic melody analysis for accompaniment on the melody file generated by the melody generating part 1423a. The harmony accompaniment generating part 1423b performs selection of a chord on the basis of analysis materials corresponding to each of measures constituting the melody. Here, the chord is an element set for each measure for harmony accompaniment. The chord is a term used for discrimination from an overall harmony of a whole musical piece.

For example, when a user plays a guitar while singing a song, he plays the guitar using chords set on respective measures. At this point, a portion for singing a song corresponds to an operation of composing melody, and judging and selecting chord suitable for the song each moment corresponds to an operation of the harmony accompaniment generating part 1423b.

Meanwhile, description has been made to the case of generating a music file by adding harmony accompaniment and/or rhythm accompaniment to lyrics and melody received through the user interface 1410. However, when lyrics and melody are received, lyrics and melody of a user's own making can be received. Also, existing lyrics and melody can be received. For example, the user can load the existing lyrics and melody, and modify them to make new lyrics and melody.

FIG. 13 is a flowchart illustrating a method of operating a music generating device according to the second embodiment of the present invention.

First, lyrics and melody are received through the user interface 1410 (operation 1501).

A user can input melody of his own making to the portable terminal 1400 through humming. The user interface 1410 includes a microphone to receive melody from the user. Also, the user can input melody of his own making by singing a song himself.

Also, the user interface 1410 can receive melody from the user using a keyboard mode. The user interface 1410 displays a keyboard-shaped image on the image display part and detects pressing/release of a button corresponding to a set musical scale to receive melody from the user. Since musical scales (e.g., Do, Re, Mi, Fa, Sol, La, Si, and Do) are assigned to buttons, respectively, a button selected by a user can be detected and pitch data of a note can be obtained. Also, duration data of a predetermined note can be obtained by detecting a time during which the button is pressed. At this point, it is possible to allow a user to select an octave by providing a selection button for raising or lowering the octave.

Also, the user interface 1410 can receive melody from the user using a score mode. The user interface 1410 can display a score on the image display part and receive melody from a user manipulating the buttons. For example, a note having a predetermined pitch and a predetermined duration is displayed on a score. The user can raise a height of the note by pressing a first button (Note Up), and lower the height of the note by pressing a second button (Note Down). Also, the user can lengthen duration of the note by pressing a third button (Lengthen), and shorten the duration of the note by pressing a fourth button (Shorten). Accordingly, the user can input pitch data and duration data of a predetermined note, and input melody of his own making by repeatedly performing this procedure.

Meanwhile, lyrics can be received from a user in various ways. The user interface 1410 can be modified in various ways depending on a way the lyrics are received from the user. The lyrics can be received separately from the above input melody. The lyrics can be received to a score to correspond to notes constituting the melody. The inputting of the lyrics can be processed while the user sings a song, or through a simple character input operation.

When lyrics and melody are received through the user interface 1410, the lyric processing module 1421 generates a voice file corresponding to the received lyrics, and the melody generating part 1423a of the composing module 1423 generates a melody file corresponding to the received melody (operation 1503). The voice file generated by the lyric processing module 1421, and the melody file generated by the melody generating part 1423a can be stored in the storage 1430.

Also, the harmony accompaniment generating part 1423b of the composing module 1423 analyzes the melody file to generate a harmony accompaniment file suitable for the melody (operation 1505). The harmony accompaniment file generated by the harmony accompaniment generating part 1423b can be stored in the storage 1430.

The music generating unit 1425 of the music generating module 1420 synthesizes the melody file, the voice file, and the harmony accompaniment file to generate a music file (operation 1507). The music file generated by the music generating unit 1425 can be stored in the storage 1430.

Meanwhile, though description has been made to only the case where a harmony accompaniment file is generated in operation 1505, a rhythm accompaniment file can be further generated through analysis of the melody file generated in operation 1503. In the case where the rhythm accompaniment file is further generated, the melody file, the voice file, the harmony accompaniment file, and the rhythm accompaniment file are synthesized to generate a music file in operation 1507.

The portable terminal 1400 simply receives only lyrics and melody from a user, generates harmony accompaniment and rhythm accompaniment suitable for the received lyrics and melody, and synthesize them to provide a music file. Accordingly, even an ordinary people, not a musical expert, can easily compose excellent music.

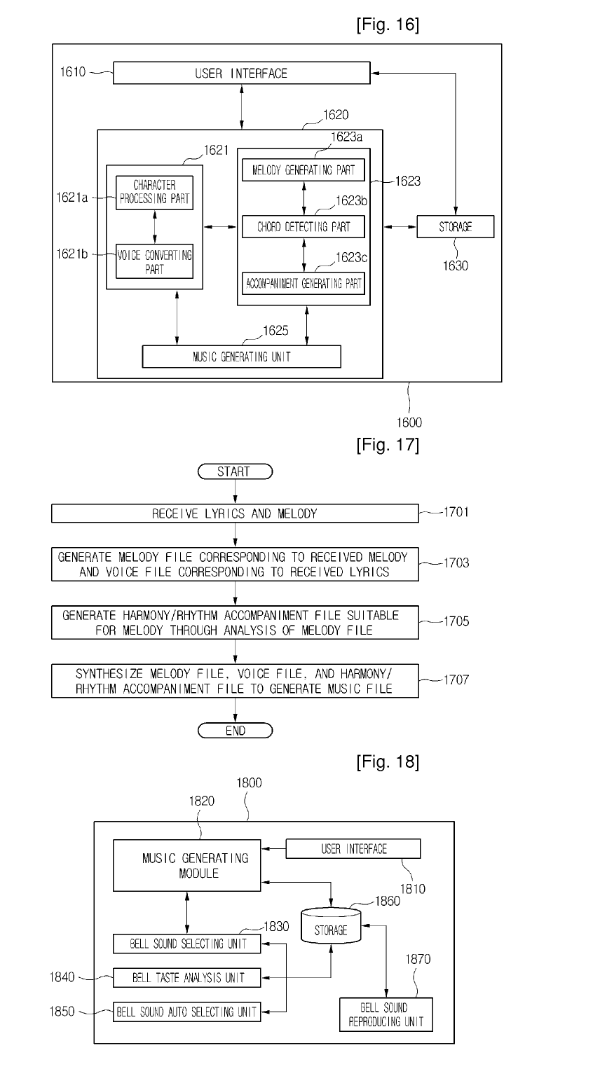

Meanwhile, FIG. 16 is a schematic block diagram of a portable terminal according to the fourth embodiment of the present invention. Here, the portable terminal is used as a term generally indicating a terminal that can be carried by an individual. The portable terminal includes MP3 players, PDAs, digital cameras, mobile communication terminals, and camera phones.

Referring to FIG. 16, the portable terminal 1600 includes a user interface 1610, a music generating module 1620, and a storage 1630. The music generating module 1620 includes a lyric processing module 1621, a composing module 1623, and a music generating unit 1625. The lyric processing module 1621 includes a character processing part 1621a and a voice converting part 1621b. The composing module 1623 includes a melody generating part 1623a, a chord detecting part 1623b, and an accompaniment generating part 1623c.

The user interface 1610 receives lyrics and melody from a user. Here, the melody received from a user means linear connection of notes formed by horizontal combination of notes having pitch and duration.

The character processing part 1621a of the lyric processing module 1621 discriminates enumeration of simple input characters into meaningful words or word-phrases. The voice converting part 1621b of the lyric processing module 1621 generates a voice file corresponding to input lyrics with reference to processing results at the character processing part 1621a. The generated voice file can be stored in the storage 1630. At this point, tone qualities such as those of woman/man/soprano voice/husky voice/child can be selected from a voice database.

The user interface 1610 receives data, commands, selection from the user, and provides sound data and visual data to the user. Also, the user interface 1610 receives lyrics and melody from the user. Here, the melody received from the user means linear connection of notes formed by horizontal combination of notes having pitch and duration.

The music generating module 1620 generates harmony/rhythm accompaniment suitable for the lyrics and melody received through the user interface 1610. The music generating module 1620 generates a music file where the generated harmony accompaniment/rhythm accompaniment is added to the lyrics and melody received from the user.

The portable terminal 1600 according to the present invention receives only lyrics and melody simply and generates and synthesizes harmony accompaniment/rhythm accompaniment suitable for the received lyrics and melody to provide a music file. Accordingly, even an ordinary people, not a musical expert, can easily compose an excellent musical piece.

The melody generating part 1623a of the composing module 1623 can generate a melody file corresponding to melody input through the user interface 1610, and store the generated melody file in the storage 1630.

The chord detecting part 1623b of the composing module 1623 analyzes the melody file generated by the melody generating part 1623a, and detects a chord suitable for the melody. The detected chord can be stored in the storage 1630.

The accompaniment generating part 1623c of the composing module 1623 generates an accompaniment file with reference to the chord detected by the chord detecting part 1623b. Here, the accompaniment file means a file containing both harmony accompaniment and rhythm accompaniment. The accompaniment file generated by the accompaniment generating part 1623c can be stored in the storage 1630.

The music generating unit 1625 can synthesize the melody file, the voice file, and the accompaniment file stored in the storage 1630 to generate a music file, and store the generated music file in the storage 1630.

The portable terminal 1600 simply receives only lyrics and melody from a user, generates harmony accompaniment/rhythm accompaniment suitable for the received lyrics and melody, and synthesize them to provide a music file. Accordingly, even an ordinary people, not a musical expert, can easily compose excellent music.

Melody can be received from a user in various ways. The user interface 1610 can be modified in various ways depending on a way the melody is received from the user. Melody can be received from the user through modes such as a humming mode, a keyboard mode, and a score mode.

Hereinafter, an operation of detecting, at the chord detecting part 1623b, a chord suitable for received melody will be descried briefly. The operation of detecting a chord, which will be descried below, can be applied also to the portable terminal 1400 according to the third embodiment of the present invention.

The chord detecting part 1623b analyzes received melody to divide measure to be suitable for a predetermine time designated in advance. For example, in the case of a musical piece having a four-four time, duration of notes is calculated by a four-time unit and divided on a music sheet (refer to FIG. 10). In the case where notes are arranged across a measure, the notes can be divided using a tie.

The chord detecting part 1623b classifies notes of melody into a twelve-tone scale and gives weight to the notes according to the duration of each note (one octave is divided into twelve tones, and for example, one octave consists of twelve tones represented by twelve keyboards including a white keyboard and a black keyboard in keyboards of a piano). For example, since influence determining chord is high as duration of a note is lengthened, high weight is given to a note having a relatively long duration and small weight is given to a note having a relatively short duration. Also, an accent condition suitable for time is considered. For example, a musical piece of a four-four time has a rhythm of strong/weak/intermediate/weak, in which a higher weight is given to a note corresponding to strong/intermediate rather than other notes to allow the note corresponding to strong/intermediate rhythm to have much influence when chord is selected.

As descried above, the chord detecting part 1623b gives weight where various conditions are summed for respective notes to provide melody analysis materials so that most harmonious accompaniment is achieved when chord is selected afterward.

The chord detecting part 1623b judges which major/minor key a whole musical piece has using the materials analyzed for the melody. Key includes C major, G major, D major, and A major determined by the number of # (sharp), and also includes F major, Bb major, and Eb major determined by the number of b (flat). Since chord used for each key is different, this analysis is required.

The chord detecting part 1623b maps chord most suitable for each measure with reference to analyzed key data and weight data for respective notes. The chord detecting part 1623b can assign chord to one measure, or assign chord to half measure depending on distribution of notes when assigning chord for each measure.

Through this process, the chord detecting part 1623b can analyze melody received from the user, and detect a suitable chord corresponding to each measure.

The accompaniment generating part 1623c selects a style of accompaniment to be added to melody received from a user. The accompaniment style includes hip-hop, dance, jazz, rock, ballad, and trot. The accompaniment style to be added to the melody received from the user may be selected by the user. A chord file according to each style can be stored in the storage 1630. Also, the chord file according to each style can be generated for each instrument. The instrument includes a piano, a harmonica, a violin, a cello, a guitar, and a drum. A reference chord file corresponding to each instrument can be generated in duration of one measure and formed of basic I chord. Of course, a reference chord file according to each style may be managed as a separate database, and may be provided as other chord such as a IV chord and a V chord.

Since a hip-hop style selected by the accompaniment generating part 1623c includes a basic I chord, but measure detected by the chord detecting part 1623b may be matched to a IV chord or a V chord, not a basic I chord, the accompaniment generating part 1623c modifies a reference chord according to a selected style into a chord of each measure actually detected. Accordingly, the accompaniment generating part 1623c performs an operation of modifying a reference chord into a chord suitable for actually detected measure. Of course, an operation of individually modifying a chord with respect to all instruments constituting a hip-hop style is performed.

The accompaniment generating part 1623c sequentially connects the modified chords for each instrument. For example, the accompaniment generating part 1623c applies a I chord of a hip-hop style to a first measure, a IV chord of a hip-hop style to a front half of a second measure, and a V chord of a hip-hop style to a rear half of the second measure. As described above, the accompaniment generating part 1623c sequentially connects chords of hip-hop style suitable for respective measures. At this point, the accompaniment generating part 1623c sequentially connects the chords along measures for each instrument, and connects the chords depending on the number of instruments. For example, a piano chord of a hip-hop style is applied and connected, and a drum chord of a hip-hop style is applied and connected.

The accompaniment generating part 1623c generates an accompaniment file formed by chords connected for each instrument. This accompaniment file can be generated using respective independent MIDI tracks formed by chords connected for each instrument. The above-generated accompaniment file can be stored in the storage 1630.

The music generating unit 1625 synthesizes a melody file, a voice file, an accompaniment file stored in the storage 1630 to generate a music file. The music file generated by the music generating unit 1625 can be stored in the storage 1630. The music generating unit 1625 can gather at least one MIDI track generated by the accompaniment generating part 1623c and lyrics/melody tracks received from the user together with header data to generate one completed MIDI file.

Meanwhile, though description has been made for the case where a music file is generated by adding accompaniment to lyrics and melody received through the user interface 1610, not only lyrics and melody of the user's own making can be received, but also existing lyrics/melody can be received through the user interface 1610. For example, the user can call the existing lyrics and melody stored in the storage 1630, and may modify the existing lyrics and melody to make new one.

FIG. 17 is a schematic flowchart illustrating a method of operating a portable terminal according to the fourth embodiment of the present invention.

First, lyrics and melody are received through the user interface 1410 (operation 1701).

A user can input melody of his own making to the portable terminal 1600 through humming. The user interface 1610 includes a microphone to receive melody from the user. Also, the user can input melody of his own making by singing a song himself.

Also, the user interface 1610 can receive melody from the user using a keyboard mode. The user interface 1610 displays a keyboard-shaped image on the image display part and detects pressing/release of a button corresponding to a set musical scale to receive melody from the user. Since musical scales (e.g., Do, Re, Mi, Fa, Sol, La, Si, and Do) are assigned to buttons, respectively, a button selected by a user can be detected and pitch data of a note can be obtained. Also, duration data of a predetermined note can be obtained by detecting a time during which the button is pressed. At this point, it is possible to allow a user to select an octave by providing a selection button for raising or lowering the octave.

Also, the user interface 1610 can receive melody from the user using a score mode. The user interface 1610 can display a score on the image display part and receive melody from a user manipulating the buttons. For example, a note having a predetermined pitch and a predetermined duration is displayed on a score. The user can raise a height of the note by pressing a first button (Note Up), and lower the height of the note by pressing a second button (Note Down). Also, the user can lengthen duration of the note by pressing a third button (Lengthen), and shorten the duration of the note by pressing a fourth button (Shorten). Accordingly, the user can input pitch data and duration data of a predetermined note, and input melody of his own making by repeatedly performing this procedure.

Meanwhile, lyrics can be received from a user in various ways. The user interface 1610 can be modified in various ways depending on a way the lyrics are received from the user. The lyrics can be received separately from the above input melody. The lyrics can be received to a score to correspond to notes constituting the melody. The inputting of the lyrics can be processed while the user sings a song, or through a simple character input operation.

When lyrics and melody are received through the user interface 1610, the lyric processing module 1621 generates a voice file corresponding to the received lyrics, and the melody generating part 1623a of the composing module 1623 generates a melody file corresponding to the received melody (operation 1703). The voice file generated by the lyric processing module 1621, and the melody file generated by the melody generating part 1623a can be stored in the storage 1630.

The music generating module 1620 analyzes melody generated by the melody generating part 1623a, and generates a harmony/rhythm accompaniment file suitable for the melody (operation 1705). The generated harmony/rhythm accompaniment file can be stored in the storage 1630.

Here, the chord detecting part 1623b of the music generating module 1620 analyzes melody generated by the melody generating part 1623a, and detects a chord suitable for the melody. The detected chord can be stored in the storage 1630.

The accompaniment generating part 1623c of the music generating module 1620 generates an accompaniment file with reference to the chord detected by the chord detecting part 1623b. Here, the accompaniment file means a file including both harmony accompaniment and rhythm accompaniment. The accompaniment file generated by the accompaniment generating part 1623c can be stored in the storage 1630.

Subsequently, the music generating unit 1625 of the music generating module 1620 synthesizes the melody file, the voice file, and the harmony/rhythm accompaniment file to generate a music file (operation 1707). The music file generated by the music generating unit 1625 can be stored in the storage 1630.

The portable terminal 1600 simply receives only lyrics and melody from a user, generates harmony/rhythm accompaniment suitable for the received lyrics and melody, and synthesize them to provide a music file. Accordingly, even an ordinary people, not a musical expert, can easily compose excellent music.

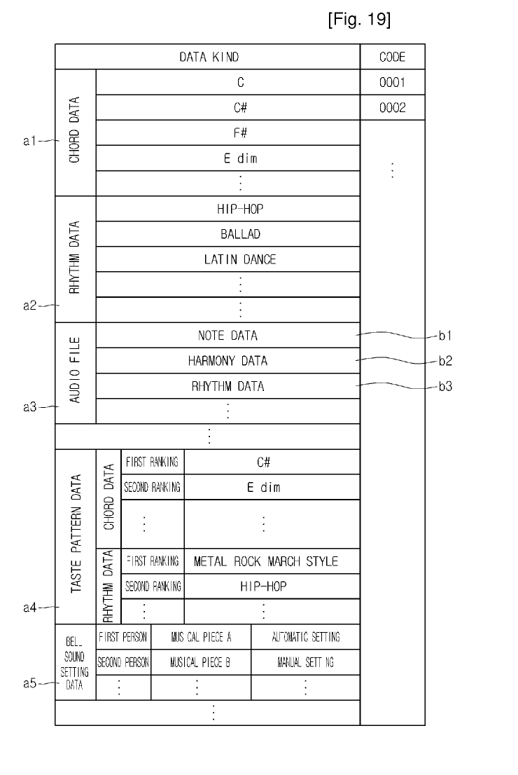

FIG. 18 is a schematic block diagram of a mobile communication terminal according to the fifth embodiment of the present invention, and FIG. 19 is a view illustrating a data structure exemplifying a kind of data stored in a storage of a mobile communication terminal according to the fifth embodiment of the present invention.

Referring to FIG. 18, the mobile communication terminal 1800 includes a user interface 1810, a music generating module 1820, a bell sound selecting unit 1830, a bell sound taste analysis unit 1840, a bell sound auto selecting unit 1850, a storage 1860, and a bell sound reproducing unit 1870.

The user interface 1810 receives data, commands, and selection from the user, and provides sound data and visual data to the user. Also, the user interface 1810 receives lyrics and melody from the user. Here, the melody received from the user means linear connection of notes formed by horizontal combination of notes having pitch and duration.

The music generating module 1820 generates harmony/rhythm accompaniment suitable for the lyrics and melody received through the user interface 1810. The music generating module 1820 generates a music file where the generated harmony accompaniment/rhythm accompaniment is added to the lyrics and melody received from the user.

The music generating module 1420 applied to the portable terminal according to the third embodiment of the present invention, or the music generating module 1620 applied to the portable terminal according to the fourth embodiment of the present invention may be selected as the music generating module 1820.

The portable terminal 1800 according to the present invention receives only lyrics and melody simply and generates and synthesizes harmony accompaniment/rhythm accompaniment suitable for the received lyrics and melody to provide a music file. Accordingly, even an ordinary people, not a musical expert, can easily compose an excellent musical piece. Also, the user can transfer a music file of his own making to other person, and can utilize the music file as a bell sound of the mobile communication terminal 1800.

The storage 1860 stores chord data a1, rhythm data a2, an audio file a3, symbol pattern data a4, and bell sound setting data a5.

Referring to FIG. 19, first, the chord data a1 is harmony data applied to notes constituting predetermined melody on the basis of a difference (greater than two scales) between musical scales, i.e., an interval theory.

Therefore, even in the case where simple lyrics and a melody line are input through the user interface 1810, the chord data a1 allows accompaniment to be realized by a predetermined reproduction unit of notes (e.g., a measure of a musical piece performed for each time).

Second, the rhythm data a2 is a range data played using a percussion instrument such as a drum, and a rhythm instrument such as a base guitar. The rhythm data a2 is made using beat and accent, and includes harmony data and various rhythms according to a time pattern. According to this rhythm data a2, a variety of rhythm accompaniment such as ballad, hip-hop, and Latin dance can be realized for each predetermined reproduction unit (e.g., a passage) of notes.

Third, the audio file a3 is a file for reproducing a musical piece. A MIDI file can be used as the audio file. Here, MIDI (musical instrument digital interface) means standard in which various signals are prescribed in order to give and take digital signals between electronic musical instruments. The MIDI file includes tone color data, a note length data, scale data, note data, accent data, rhythm data, and echo data.

Here, the tone color data is closely related to a note width, represents unique characteristic of the note, and is different depending on a kind of a musical instrument (voice).

Also, the scale data means a note pitch (generally, the scale is a seven-tone scale and is divided into a major scale, a minor scale, a half tone scale, and a whole tone scale). The note data b1 means a minimum unit of a musical piece (that can be called as music). That is, the note data b1 can serve as a unit for a sound source sample. A subtle performance distinction can be expressed by accent data, and echo data besides the scale data and the note data.

Respective data constituting the MIDI file are generally stored as audio tracks. According to an embodiment of the present invention, three representative audio tracks of a note audio track b1, a harmony audio track b2, and a rhythm audio track b3 are used for an automatic accompaniment function. Also, a separate audio track corresponding to received lyrics can be applied.

Fourth, the symbol pattern data a4 means ranking data of chord data and rhythm data favored by a user that are obtained by analyzing an audio file selected by the user. Therefore, the symbol pattern data a4 allows the user to select a favorite audio file a3 with reference to an amount of harmony data and rhythm data for each ranking.

Fifth, the bell sound setting data a5 is data in which the audio file a3 selected by the user or an audio file (which is descried below) automatically selected by analyzing the user's taste is set to be used as a bell sound.

When the user presses a predetermined key button of a keypad unit provided to the user interface 1810, a corresponding key input signal is generated and transferred to the music generating module 1820.

The music generating module 1820 generates note data including a note pitch and a note duration according to the key input signal, and forms an note audio track using the generated note data.

At this point, the music generating module 1820 maps a predetermined pitch depending on a kind of a key button, and sets a predetermined note length depending on a time for the key button is operated to generate note data. The user may input #(sharp) or b(flat) by operating a predetermined key together with key buttons assigned to notes of a musical scale. Accordingly, the music generating module 1820 generates note data such that the mapped note pitch is raised or lowered by half.

By doing so, the user inputs a basic melody line through a kind and a pressing time of the key button. At this point, the user interface 1810 generates display data that uses the generated note data as a musical symbol in real time, and displays the display data on a screen of an image display part.

For example, when notes are displayed on a musical score for each measure, the user can easily compose a melody line while checking the displayed notes.

Also, the music generating module 1820 sets two operating modes of a melody receiving mode and a melody checking mode, and can receive an operating mode from the user. The melody receiving mode is a mode for receiving note data, and the melody checking mode is a mode for reproducing melody so that the user can check input note data even while he composes a corresponding musical piece. That is, the music generating module 1820 reproduces melody according to note data generated up to now when the melody checking mode is selected.

While the melody receiving mode operates, when a input signal of a predetermined key button is transferred, the music generating module 1820 reproduces a corresponding note according to a musical scale assigned to the key button. Therefore, the user checks a note on a musical score, hears an input note every moment or reproduces an input note of up to that time to perform composition of a musical piece.

The user can compose a musical piece from the beginning using the music generating module 1820 as described above. Also, the user can perform composition/arrangement using an existing musical piece and audio file. In this case, the music generating module 1820 can read other audio file stored in a storage 1860 through selection of the user.

The music generating module 1820 detects a note audio track of a selected audio file, and the user interface 1810 outputs the note audio track on a screen in the form of musical symbols. The user who has checked the output musical symbols manipulates a keypad unit of the user interface 1810 as described above. When a key input signal is delivered, the user interface 1810 generates corresponding note data to allow the user to edit note data of the audio track.

Meanwhile, lyrics can be received from a user in various ways. The user interface 1810 can be modified in various ways depending on a way the lyrics are received from the user. The lyrics can be received separately from the above input melody. The lyrics can be received to a score to correspond to notes constituting the melody. The inputting of the lyrics can be processed while the user sings a song, or through a simple character input operation.

When note data (melody) and lyrics are input, the music generating module 1820 provides automatic accompaniment suitable for the input note data and lyrics.

The music generating module 1820 analyzes the input note data by a predetermined unit, detects applicable harmony data from the storage 1860, and generates a harmony audio track using the detected harmony data.

The detected harmony data can be combined as various kinds, and accordingly, the music generating module 1820 generates a plurality of harmony audio tracks depending on a kind and a combination of the harmony data.

The music generating module 1820 analyzes a time of the above-generated note data, detects applicable rhythm data from the storage 1860, and generates a rhythm audio track using the detected rhythm data. The music generating module 1820 generates a plurality of rhythm audio tracks depending on a kind and a combination of the rhythm data.

Also, the music generating module 1820 generates a voice track corresponding to lyrics received through the user interfaced 1810.

The music generating module 1820 mixes the above generated note audio track, voice track, harmony audio track, and rhythm audio track to generate a single audio file. Since there exist the plurality of tracks, a plurality of audio file to be used as bell sounds can be generated.

When the user inputs lyrics and a melody line via the user interface 1810 through the above process, the mobile communication terminal 1800 can automatically generate harmony accompaniment and rhythm accompaniment, and generate a plurality of audio files.

The bell sound selecting unit 1830 can provide identification data of the audio file to the user. When the user selects an audio file to be used as a bell sound through the user interface 1810, the bell sound selecting unit 1830 sets the audio file so that it can be used as a bell sound (the bell sound setting data).

The user repeatedly uses a bell sound setting function, and the bell sound setting data is recorded in the storage 1860. The bell sound taste analysis unit 1840 analyzes harmony data and rhythm data constituting the selected audio file to generate taste pattern data of the user.

The bell sound auto selecting unit 1850 selects a predetermined number of audio files to be used as a bell sound from a plurality of audio files composed or arranged by the user according to the taste pattern data.

When a communication channel is set and a lingering sound is reproduced, the bell sound reproducing unit 1870 parses a predetermined audio file to generate reproduction data of a MIDI file, and aligns the reproduction data using a time column for a reference. Also, the bell sound reproducing unit 1870 sequentially reads relevant sound sources corresponding to reproduction times of each track, and frequency—converts and outputs the read sound sources.

The frequency-converted sound sources are output as bell sounds via a speaker of the user interface 1810.

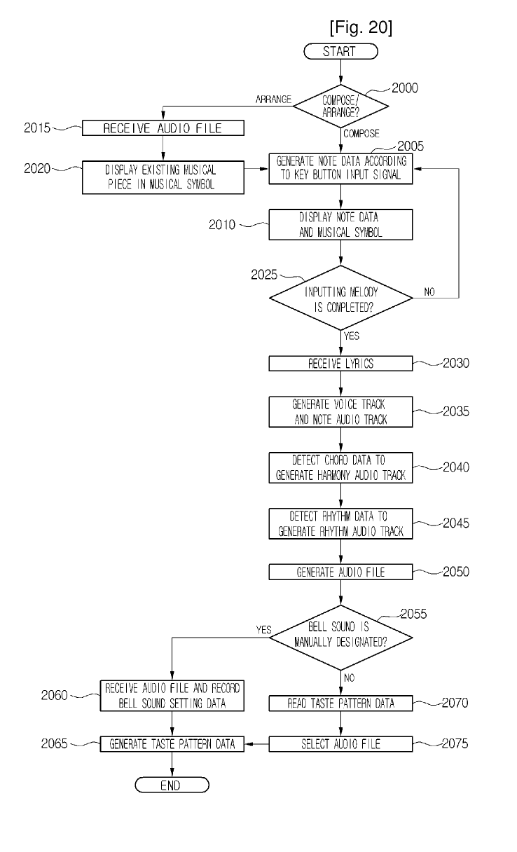

Next, a method for operating a mobile communication terminal according to a fifth embodiment of the present invention will be described with reference to FIG. 20. FIG. 20 is a flowchart illustrating a method of operating a mobile communication terminal according to the fifth embodiment of the present invention.

First, a user selects whether to newly compose a musical piece (e.g., a bell sound) or to arrange an existing musical piece (operation 2000).

In the case where the musical piece is newly composed, note data including note pitch and note duration is generated according to an input signal of a key button (operation 2005).

On the other hand, in the case where the existing musical piece is arranged, the music generating module 1820 reads a selected audio file (operation 2015), analyzes a note audio track, and outputs a musical symbol on a screen (operation 2020).

The user selects notes constituting the existing musical piece, and manipulates the keypad unit of the user interface 1810 to input notes. Accordingly, the music generating module 1820 maps note data corresponding to a key input signal (operation 2005), and outputs the mapped note data on a screen in the form of a musical symbol (operation 2010).

When a predetermined melody is composed or arranged (operation 2025), the music generating module 1820 receives lyrics from the user (operation 2030). Also, the music generating module 1820 generates a voice track corresponding to the received lyrics, and a note audio track corresponding to received melody (operation 2035).

When the note audio track corresponding to the melody is generated, the music generating module 1820 analyzes the generated note data by a predetermined unit to detect applicable chord data from the storage 1860. Also, the music generating module 1820 generates a harmony audio track using the detected chord data according to an order of the note data (operation 2040).

Also, the music generating module 1820 analyzes a time of the note data of the note audio track to detect applicable rhythm data from the storage 1860. Also, the music generating module 1820 generates a rhythm audio track using the detected rhythm data according to the order of the note data (operation 2045).

When the melody (the note audio track) is composed/arranged, an audio track corresponding to lyrics is generated, and harmony accompaniment (a harmony audio track) and rhythm accompaniment (a rhythm audio track) are automatically generated, the music generating module 1820 mixes the respective tracks to generate a plurality of audio files (operation 2050).

At this point, in the case where the user manually designates a desired audio file as a bell sound (Yes in operation 2055), the bell sound selecting unit 1830 provides identification data to receive an audio file, and records bell sound setting data on a relevant audio file (operation 2060).

The bell sound analysis unit 1840 analyzes harmony data and rhythm data of an audio file to be used as a bell sound to generate taste pattern data of a user, and records the generated taste pattern data in the storage 1860 (operation 2065).

However, in the case where the user intends to automatically designate a bell sound (No in operation 2055), the bell sound auto selecting unit 1850 analyzes an audio file composed or arranged, or audio files already stored, and matches the analysis results with the taste pattern data to select an audio file to be used as a bell sound (operations 2070 and 2075).

Even in the case where the bell sound is designated, the bell sound taste analysis unit 1840 analyzes harmony data and rhythm data of an automatically selected audio file to generate taste pattern data of a user, and records the generated taste pattern data in the storage 1860 (operation 2065).

According to a mobile communication terminal of the present invention, even when a user inputs only desired lyrics and melody or arranges melody of other musical piece, a variety of harmony accompaniments and rhythm accompaniments are generated, and mixed as a single music file, so that a plurality of beautiful bell sounds can be obtained.

Also, according to the present invention, a bell sound is designated by examining bell sound preference of a user on the basis of a musical theory such as harmony data and rhythm data converted into a database and automatically selecting newly composed/arranged bell sound contents or existing bell sound contents. Accordingly, inconvenience that a user should manually manipulates a menu in order to designate a bell sound periodically can be reduced.

Also, according to the present invention, a user can beguile the tedium as if he enjoyed a game by composing or arranging a musical piece enjoyably through a simple interface while he moves using a transportation means or waits for somebody.

Also, according to the present invention, since a bell sound source does not need to be downloaded with fee and a bell sound can be easily generated using a dead time, utility of a mobile communication terminal can be improved even more.

### INDUSTRIAL APPLICABILITY

According to a music generating device and a method for operating the same of the present invention, harmony accompaniment and rhythm accompaniment suitable for expressed lyrics and melody can be automatically generated.

Also, according to a portable terminal and a method for operating the same, harmony accompaniment and rhythm accompaniment suitable for expressed lyrics and melody can be automatically generated.

According to a mobile communication terminal and a method for operating the same, a music generating module for automatically generating harmony accompaniment and rhythm accompaniment suitable for expressed lyrics and melody is provided, so that a musical piece generated by the music generating module can be used as a bell sound.

1. A music generating device comprising:
a user interface for receiving lyrics and melody from a user;
a lyric processing module for generating a voice file corresponding to the received lyrics;
a melody generating unit for generating a melody file corresponding to the received melody;
a harmony accompaniment file for analyzing the melody file to generate a harmony accompaniment file corresponding to the melody; and
a music generating unit for synthesizing the voice file, the melody file, and the harmony accompaniment file to generate a music file.

2. The device according to claim 1, wherein the user interface detects pressing/release of a button corresponding to a note of a set musical scale to receive the melody from the user.

3. The device according to claim 1, wherein the user interface displays a score on an image display part, and receives the melody by allowing the user to manipulate a button to set a note pitch and a note duration.

4. The device according to claim 1, wherein the harmony accompaniment generating unit selects a chord corresponding to each measure for measures constituting the melody.

5. The device according to claim 1, further comprising a rhythm accompaniment generating unit for analyzing the melody file to generate a rhythm accompaniment file corresponding to the melody.

6. The device according to claim 5, wherein the music generating unit synthesizes the voice file, the melody file, the harmony accompaniment file, and the rhythm accompaniment file to generate a second music file.

7. The device according to claim 1, further comprising a storage for storing at least one of the voice file, the melody file, the harmony accompaniment file, the music file, and an existing composed music file.

8. The device according to claim 7, wherein the user interface receives and displays one of the lyrics and the melody of a file stored in the storage, and receives a modify request for one of the lyrics and the melody from the user to edit one of the lyrics and the melody.

9. The device according to claim 1, wherein the user interface receives the lyrics and the melody from a song sung by the user.

10. The device according to claim 1, wherein the user interface receives the lyrics by allowing the user to input characters.

11. The device according to claim 1, wherein the lyric processing module comprises:
a character processing part for dividing enumeration of characters of the received lyrics into one of words and phrases; and
a voice converting part for generating the voice file corresponding to the received lyrics with reference to results processed at the character processing part.

12. A music generating device comprising:
a user interface for receiving lyrics and melody from a user;
a lyric processing module for generating a voice file corresponding to the received lyrics;
a melody generating unit for generating a melody file corresponding to the received melody;
a chord detecting unit for analyzing the melody file to detect a chord for each measure constituting the melody;
an accompaniment generating unit for generating a harmony/rhythm accompaniment file corresponding to the melody with reference to the detected chord; and
a music generating unit for synthesizing the voice file, the melody file, and the harmony/rhythm accompaniment file to generate a music file.

13. The device according to claim 12, further comprising a storage for storing at least one of the voice file, the melody file, the chord for each measure, the harmony/rhythm accompaniment file, the music file, and an existing composed music file.

14. The device according to claim 13, wherein the user interface receives and displays one of the lyrics and the melody of a file stored in the storage, and receives a modify request for one of the lyrics and the melody from the user to edit one of the lyrics and the melody.

15. A portable terminal comprising:
a user interface for receiving lyrics and melody from a user; and
a music generating module for generating a voice file corresponding to the received lyrics, generating a melody file corresponding to the received melody, analyzing the generated melody file to generate a harmony accompaniment file corresponding to the melody, and synthesizing the voice file, the melody file, and the harmony accompaniment file to generate a music file.

16. A portable terminal comprising:
a user interface for receiving lyrics and melody from a user; and
a music generating module for generating a voice file corresponding to the received lyrics, generating a melody file corresponding to the received melody, analyzing the melody file to detect a chord for each measure constituting the melody, generating a harmony/rhythm accompaniment file corresponding to the melody with reference to the detected chord, and synthesizing the voice file, the melody file, and the harmony/rhythm accompaniment file to generate a music file.

17. A mobile communication terminal comprising:
a user interface for receiving lyrics and melody from a user; and
a music generating module for generating a voice file corresponding to the received lyrics, generating a melody file corresponding to the received melody, analyzing the generated melody file to generate an accompaniment file having harmony accompaniment corresponding to the melody, synthesizing the voice file, the melody file, and the accompaniment file to generate a music file;
a bell sound selecting unit for selecting the music file generated by the music generating module as a bell sound; and
a bell sound reproducing unit for reproducing the music file selected by the bell sound selecting unit as the bell sound when communication is connected.

18. A method for operating a music generating device, the method comprising:
receiving lyrics and melody via a user interface;
generating a voice file corresponding to the received lyrics and generating a melody file corresponding to the received melody;
analyzing the melody file to generate a harmony accompaniment file suitable for the melody; and
synthesizing the voice file, the melody file, and the harmony accompaniment file to generate a music file.

19. The method according to claim 18, wherein the analyzing of the melody file to generate the harmony accompaniment file comprises selecting a chord corresponding to each measure for measures constituting the melody.

20. The method according to claim 18, further comprising generating a rhythm accompaniment file corresponding to the melody through analysis of the melody file.

21. The method according to claim 20, further comprising synthesizing the voice file, the melody file, the harmony accompaniment file, and the rhythm accompaniment file to generate a second music file.

22. The method according to claim 18, wherein the user interface receives the lyrics and the melody from a song sung by the user.

23. The method according to claim 18, wherein the user interface receives the lyrics by allowing the user to input characters.

24. A method for operating a music generating device, the method comprising:
receiving lyrics and melody via a user interface;
generating a voice file corresponding to the received lyrics and generating a melody file corresponding to the received melody;
analyzing the melody file to generate a harmony/rhythm accompaniment file suitable for the melody; and
synthesizing the voice file, the melody file, and the harmony/rhythm accompaniment file to generate a music file.

25. A method for operating a mobile communication terminal, the method comprising:
receiving lyrics and melody through a user interface;
generating a voice file corresponding to the received lyrics and generating a melody file corresponding to the received melody;
analyzing the melody file to generate an accompaniment file having harmony accompaniment suitable for the melody;
synthesizing the voice file, the melody file, and the accompaniment file to generate a music file;
selecting the generated music file as a bell sound; and
when communication is connected, reproducing the selected music file as the bell sound.
